(19) United States
(12) Patent Application Publication
(10) Pub. No.: US 2016/0332482 A1
(43) Pub. Date: Nov. 17, 2016

(54) TIRE HANDLING SYSTEM

(71) Applicant: DUAL GRAPPLE AMERICA LLC, Chatsworth, IL (US)

(72) Inventor: Steve Moore, Chatsworth, IL (US)

(21) Appl. No.: 15/151,596

(22) Filed: May 11, 2016

Related U.S. Application Data
(60) Provisional application No. 62/160,062, filed on May 12, 2015.

(51) Int. Cl. B60B 30/02; B60B 29/00; B66F 9/18

(52) U.S. Cl. CPC B60B 30/02; B66F 9/18; B60B 29/00

(57) ABSTRACT

A tire handling system for removing, transporting and replacing a large tire on a vehicle, such as a farm tractor or other large machinery, is disclosed. The system includes a platform for attachment to a vehicle, such as a forklift, a grapple for engaging and securing a large tire, and a connector between the platform and the grapple for allowing pivoting and rotation of the grapple to facilitate handling of the tire. Hydraulic pistons are used to pivot the grapple and move adjustable arms to tightly and safely bind the tire within engagement brackets of the grapple. The combination of the lift movement, including the up and down of the fork, and the grapple pivoting and rotation, allows large tires to be removed from, transported and replaced on vehicles more effectively, efficiently and safely than any prior system and method.

### RELATED APPLICATION

The present application claims the filing benefit of U.S. Provisional Application No. 62/160,062, titled “Tire Handling System” and filed on May 12, 2015. The '062 Provisional Application is hereby incorporated by references.

### TECHNICAL FIELD OF THE INVENTION

The present application relates to a handling system for large tires, such as those used on semi-trucks, agriculture equipment, road construction machinery, and the like. Particularly, the application relates to a handling system for safely lifting and moving large tires from and onto such machinery.

### BACKGROUND OF THE INVENTION

Large tires used on trucks, heavy machinery and agriculture equipment, such as farm tractors and the like, can weigh from several hundred pounds to well-over a thousand pounds. Like much smaller tires, these treaded giants occasionally require removal for repair or replacement. However, for even two men, the task of removing, moving and replacing a tire on this type of heavy equipment can be an extremely difficult and potentially dangerous task (e.g., see https://www.youtube.com/watch?v=fnV1R7m1Oms).

Further, due to the cost of such the heavy machinery there is often no backup, which makes it very critical to many day-to-day operations. Prolonged downtime of, for example, a farmer's tractor can set scheduled operations well-behind and must be minimized as much as possible. That said, manual tire removal and replacement can result in a significant amount of tractor downtime, especially where only a single person is involved.

For these reasons, it is important to provide a device which can help reduce the physical strength required as well as practically eliminate the safety risk involved with changing a bad tire. These and other problems are addressed by the present device and methods to provide a system with numerous advantages in operation and effectiveness.

### SUMMARY OF THE INVENTION

There is disclosed herein a tire handling system, device and method which avoids the disadvantages of prior devices while affording additional structural and operating advantages.

The tire handling system is preferably capable of being attached to a forklift (or similar vehicle) having controls for operation of a movable carriage having at least two forks. Generally speaking, the system comprises a platform which attaches to the forks of the lift carriage, a grapple comprised of a plurality of arms, and a connection between the platform and the grapple which allows pivoting and rotation of the grapple.

In a more specific embodiment, each of the arms includes a stationary portion and an engagement bracket, and at least one arm includes an adjustable portion for extending and contracting a length of the at least one arm with the engagement bracket positioned on the adjustable portion. Further, the plurality of arms are arranged to define an area between the engagement brackets having a perimeter greater than the circumference of a tire to be handled.

In a preferred embodiment, a first hydraulic cylinder is connected to the adjustable portion of the at least one arm of the grapple to move the adjustable portion inward and outward, as needed. Most preferably, each of the plurality of arms includes an adjustable portion for extending and contracting a length of the arm with the engagement bracket positioned on the adjustable portion of the arm and each of the plurality of arms includes a first hydraulic cylinder connected to the adjustable portion.

In another embodiment, a second hydraulic cylinder is positioned on the platform and is connected by one end to the platform and by another end to the grapple for moving the grapple via the connector. In embodiments using the hydraulic cylinders, it is preferred that each be operated by a controller positioned on the platform of the tire handling system. Alternatively, the tire handling system may be connected to the forklift (or other vehicle) controls for operation.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIGS. 1-3 illustrate an embodiment of the tire handling system attached to a forklift and used for the removal of a large tire from a farm tractor, the transport of the tire being held within the grapple, and the placement of the tire on a flatbed;

FIG. 4 is a side perspective view of a three-armed embodiment of a tire handling system as described herein;

FIG. 5 is a front perspective view of the three-armed tire handling system of FIG. 4, with an inset showing the possible rotation of the connector;

FIG. 6 is a top view of an embodiment of a platform used to interface with a forklift;

FIG. 7 is a perspective view of an embodiment of the grapple having the stationary portion of the arms attached to a central hub;

FIG. 8 is a side view of an embodiment of the tire handling system attached to a fork lift and holding a tire in a front-facing position;

FIG. 9 is a front view of the embodiment of FIG. 8 showing the tire being held in a downward facing position;

FIG. 10 is a rear view of the tire handling system positioned as shown in FIG. 8;

FIG. 11 is a side view of the tire handling system positioned as shown in FIG. 9;

FIG. 12 is a perspective view of the tire handling system of FIG. 9 after releasing the tire;

FIG. 13 is a perspective view of an embodiment of the tire handling system being operated with a self-contained controller, including a push-button remote; and

FIG. 14 is a close up of a wired push-button remote for controlling operation of the embodiment of FIG. 13.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

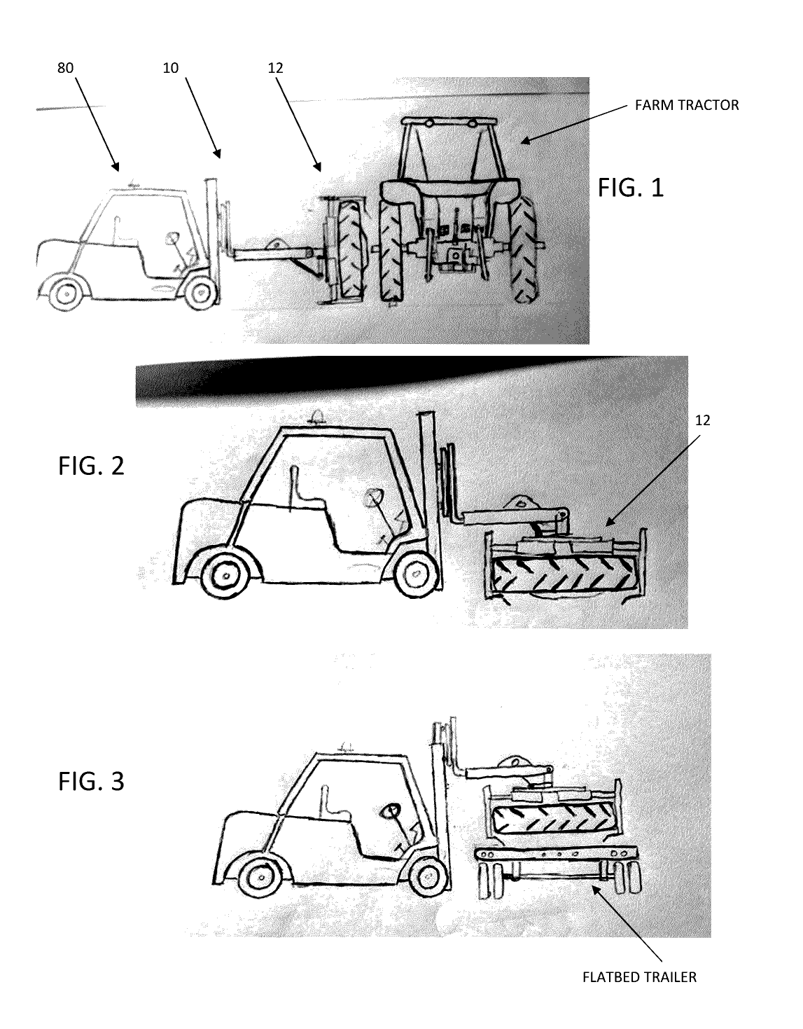

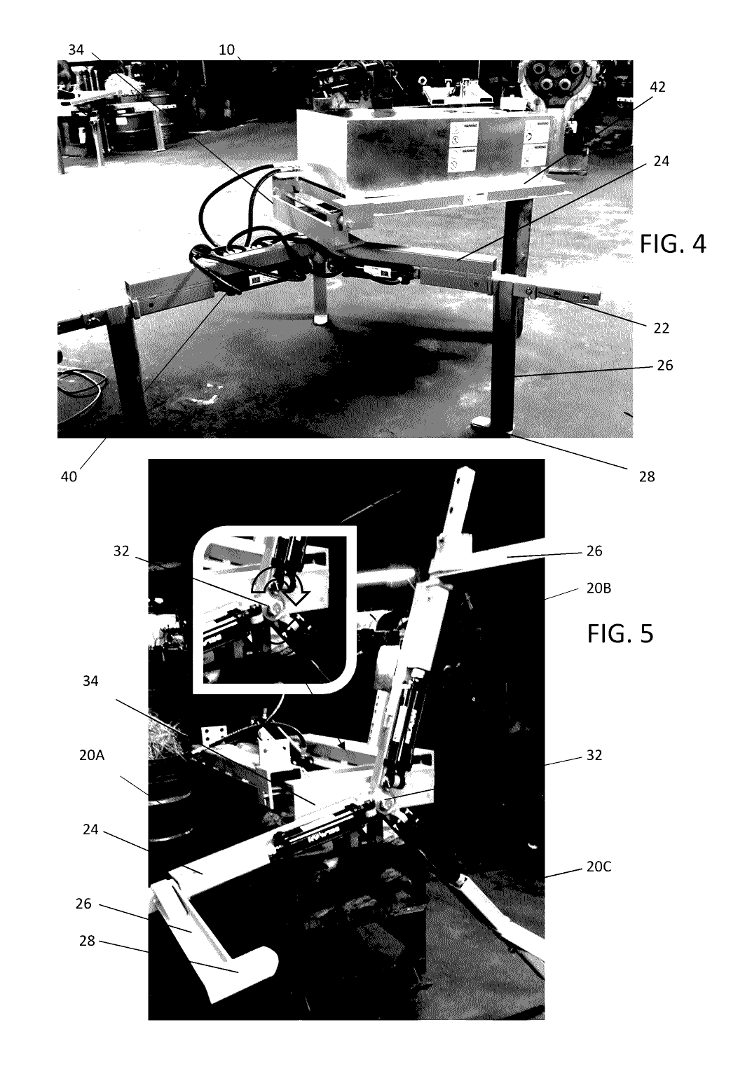

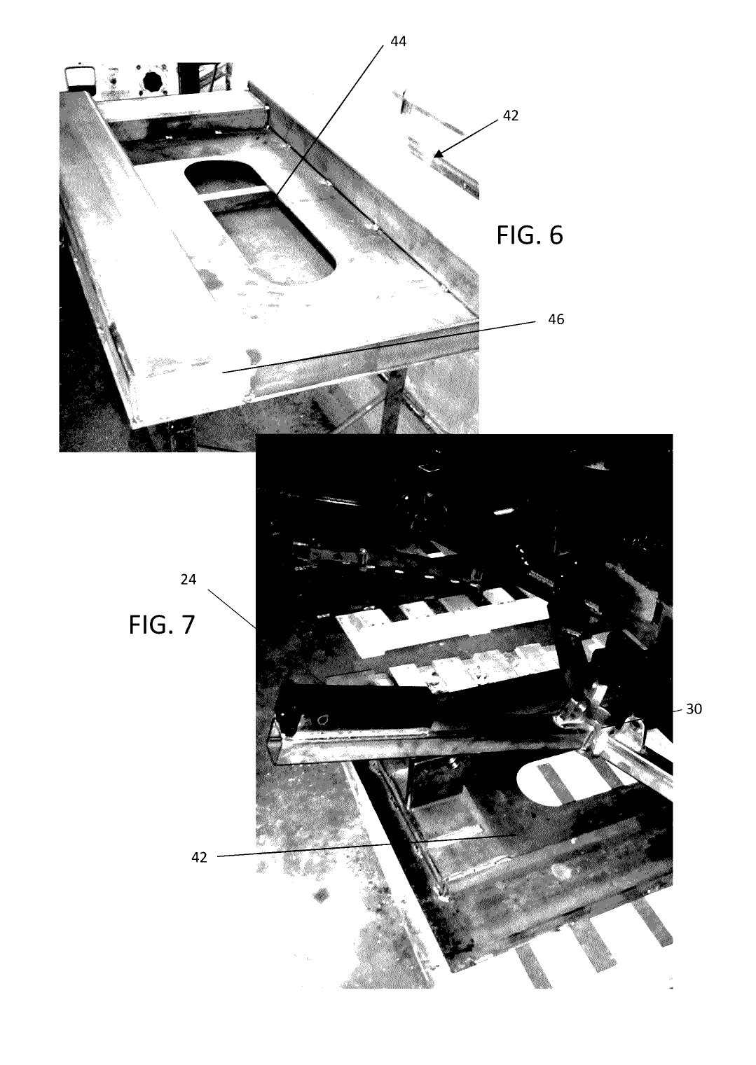

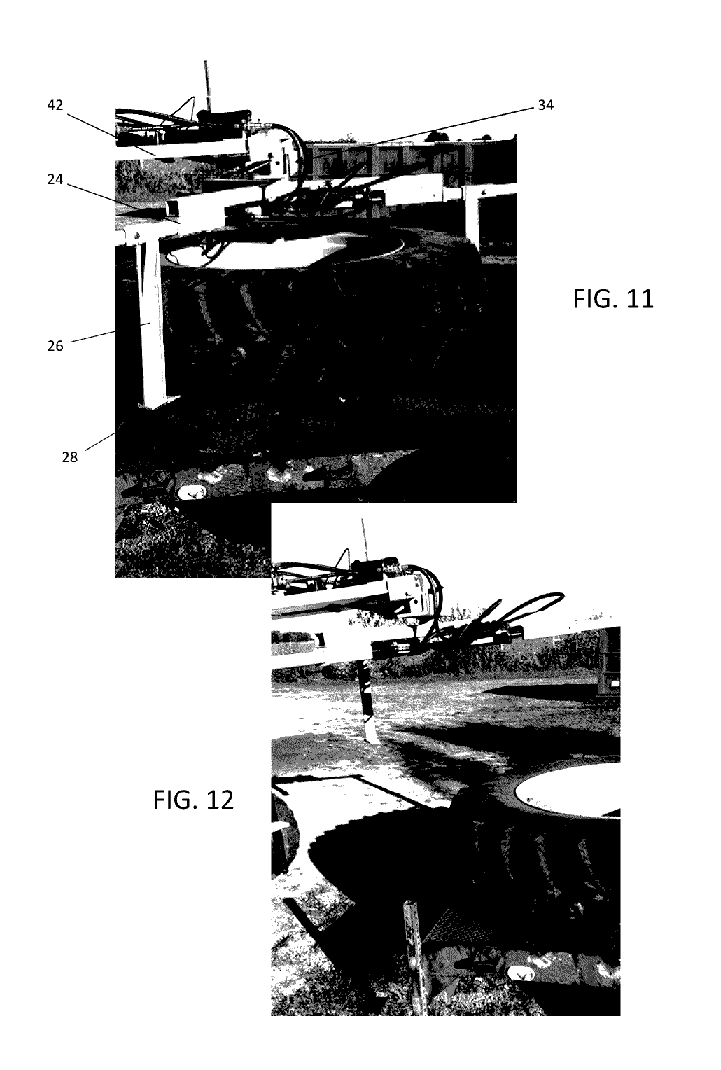

Referring now to FIGS. 1-14, there is illustrated an embodiment of a tire handling system generally referenced by the numeral 10. The following is a listing of components as described below and as labeled in the twelve appended drawing figures:
12—Grapple;
20—Arms for grapple (three arms (i.e., Ann A, Arm B and Arm C) used in illustrated embodiment);
22—Adjustable portion of grapple arms;
24—Stationary portion of the grapple arms;
26—Engagement bracket;
28—Flange;
30—Central hub;
32—Connector, allows arms to rotate approximately ±10 degrees to align tire holes and lug bolts;
34—Pivot;
40—Hydraulic cylinders to operate arms;
42—Platform used to support grapple;
44—Opening in platform for hydraulic cylinder;
46—Channels for forks on forklift;
50—Second hydraulic cylinder, moves the hinge and grapple within a 90 degree arc from horizontal to vertical;
52—Controller;
54—Remote; and
56—Push-buttons (A-E).

As shown in FIGS. 1-3, the system 10 is generally comprised of a grapple 12 attached to a forklift 80 (or similar vehicle) which has the ability to grasp and hold a large tire. The system 10, in combination with the forklift, is used to remove, transport and replace these large tires on big machinery, such as farm and construction equipment. In fact, the inventive system 10 can be used, with possible modifications, for large road equipment, trucks, military vehicles, and most any other vehicle which has large heavy tires.

Further, while the illustrated tire handling system 10 is for attachment to a forklift 80, modifications can be made for direct attachment to the boom of a service truck, or the like (not shown). In fact, the grapple 12 may even be made part of stand-alone “vehicle” which can be manually wheeled about and positioned as desired by an individual. A key component to each of these embodiments, as will be described below, is the ability of the grapple 12 to pivot and rotate to be best positioned for engaging the tire properly. As a result, the multi-armed grapple 12 is capable of engaging and holding a large tire in an advantageous vertical and horizontal position. The present invention allows large tires to be removed, transported and replaced by a single person, safely and effectively.

Referring now to the illustrated preferred embodiment of the system 10 in FIGS. 3-10, the grapple 12 comprises three arms 20A-20C and a central hub 30 from which the arms extend. Each arm 20 is comprised of an adjustable portion 22, a stationary portion 24, and an engagement bracket 26. A flange 28 is preferably positioned at the end of each bracket 26 to further secure a tire within the grapple 12.

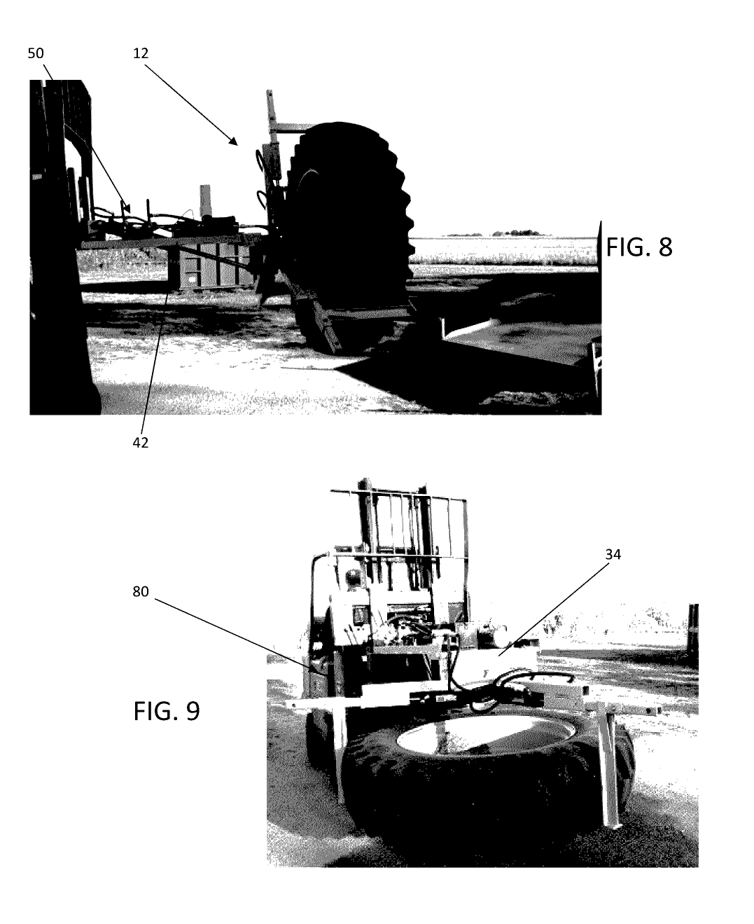

A connector 32 links the central hub 30 to a pivot 34, which is connected to a platform 42. The connector 32 most importantly provides the ability to rotate the arms 20A-20C about an axis through the central hub 30 to facilitate tire alignment. The rotation is preferably ±20 degrees, and most preferably ±10 degrees. The pivot 34 allows the grapple 12 to be pivoted in a vertical direction (i.e., up and down) from a forward facing position (FIG. 8) through a downward facing position (FIG. 9). The pivoting and rotation may be provided by a single connector or two different connectors working together.

While it is possible that the adjustable portion 22 of each arm 20A-C could be made to be manually moved, as would be understood by those of skill in the art, a hydraulic cylinder 40 is preferably attached for movement of at least one arm 20. Having just one arm hydraulically driven would require the other arms 20 to be manually set to engage the tire first. Then, the final arm 20 would be hydraulically moved to tightly engage the tire. Of course, having all three arms 20A-C separately controlled by hydraulic cylinders 40A-C would provide the most preferred, safest and easiest tire handling system 10.

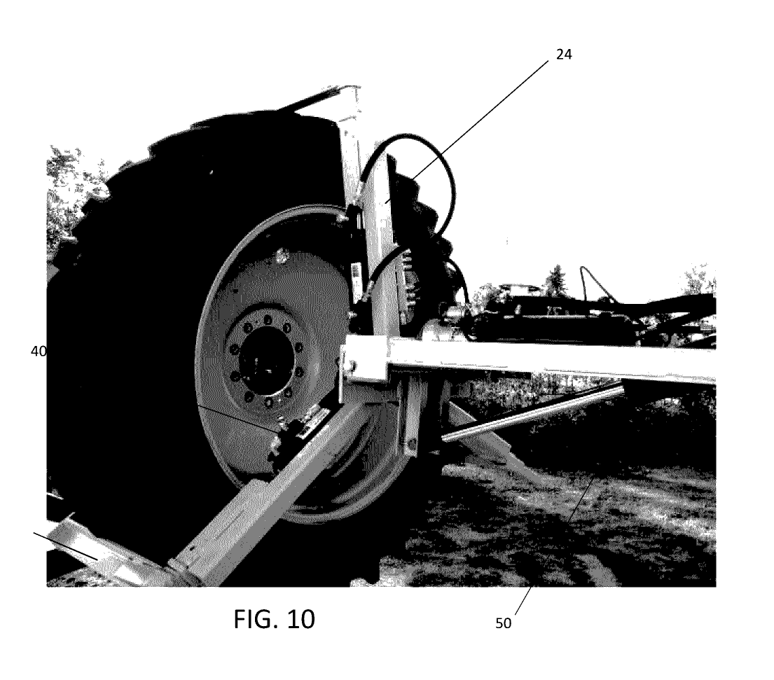

The platform 42 provides attachment to the fork of a lift (e.g., a forklift) with two open channels 46 for insertion of the forks, much like a standard pallet. This attachment allows the entire grapple 12 to be advantageously moved up and down on the carriage of the lift fork. An opening 44 on the platform 42 allows a second hydraulic cylinder 50 to couple to the pivot 34, as shown in FIG. 10. As the hydraulic cylinder 50 pushes outward, the pivot 34 pivots the grapple 12 into the forward facing position. Conversely, as the hydraulic cylinder 50 retracts, the pivot 34 pivots the grapple 12 into a downward facing position.

In the illustrated embodiment of FIGS. 8 and 9, the handling system 10 is attached to a working forklift 80 by inserting the fork tines of the forklift into channels 46 platform 42. The handling system 10 may include a locking mechanism (e.g., a pin or clamp) to then secure the handling system 10 onto the fork tines. Hydraulic controls may be self-contained on the handling system 10 or, as an alternative, may be provided by the forklift itself. For the latter configuration, connection of hydraulic lines and the like would be required. Connection of the system 10 hydraulics to those of the forklift is not further described herein, as it would be understood by those of skill in the art. However, preferably the tire handling system is completely self-contained, as will be described in further detail below.

In use, the grapple 12 is pivoted upward to a vertical position by extending the second hydraulic cylinder 50 which operates the pivot 34. The handling system 10 can then be positioned vertically by moving the forks of the forklift up or down. The adjustable portions 22 of the three arms 20A-C should be extended, either manually or hydraulically, such that the area between the respective engagement brackets 26 is greater than the tire to be engaged. The spread of the adjustable arms should be greater than the tire size to allow for the flange 28 on each engagement bracket 26 to clear the tire.

As shown, all three of the adjustable portions 22 are operated by hydraulic cylinders 40. However, one or all of the three adjustable portions 22 may be adjusted manually where the hydraulic cylinders are not provided. Manual adjustment can be a sliding portion which moves into and out of the stationary portion 24 or it may be provided through a mechanical means, such as a worm gear, wheel gear, or the like.

Once the arms 20A-C are positioned properly, the grapple 12 can be advanced into engagement with the tire as shown, by movement of the forklift. Once in position, the adjustable portion 22 of the arms (including manual and hydraulic arms) 20A-C can be contracted to place the engagement bracket 26 in contact with the tire to secure the tire within the grapple 12. The tire lugs can then be removed to free the tire from the vehicle. The tire can then be removed by reversing the direction of the forklift—being sure the vehicle is properly supported by a jack, jack stand or blocks.

Once clear of the vehicle, the handling system 10 can then be raised, via the lift carriage, and the grapple 12 can be pivoted downward by retracting the second hydraulic cylinder 50. The tire can then be transported in this position to a shop, trailer bed, or the like where the lowering of the fork places the tire upon a sufficient support surface. By opening the grapple arms 20A-C to allow the flanges 28 to clear the tire, the grapple 12 can then be raised and the tire is suitable to be worked upon. The tire can also be placed in a vertical position, if needed, though this can be a danger in light of the possible tipping of the tire once released.

Reversing the above process will return the repaired or replacement tire onto the vehicle. Further, the pivot 34 allows the grapple 12 to be rotated ±20 degrees (i.e., left or right), and most preferably at least ±10 degrees to align the tire holes and lug bolts.

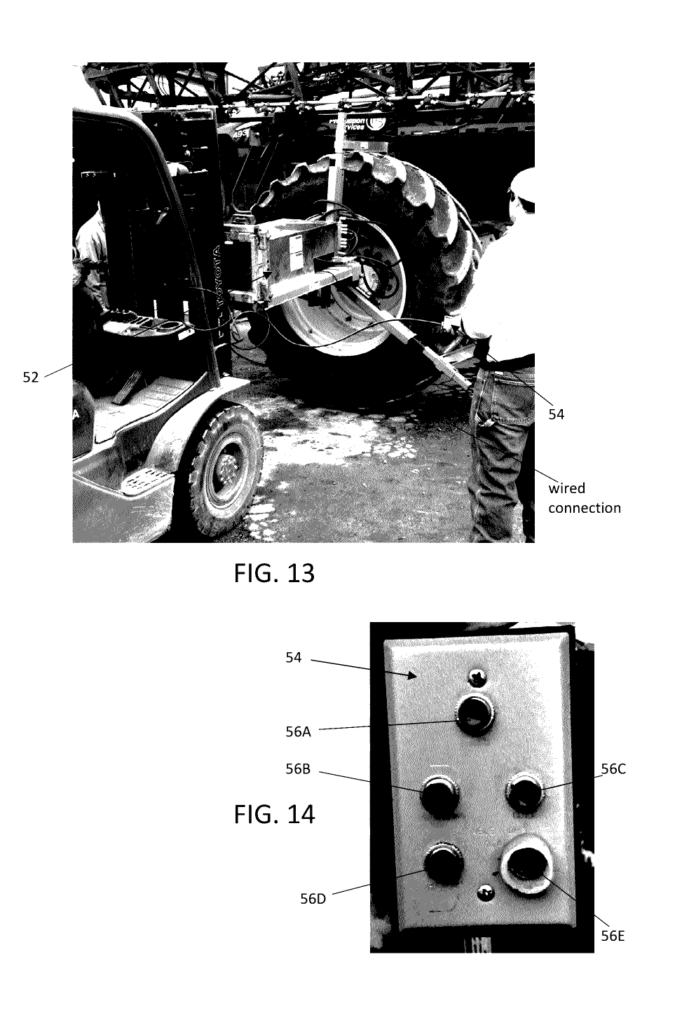

As noted above, the tire handling system 10 is preferably self-contained. Accordingly, as shown in FIGS. 13 and 14, the preferred embodiment includes a controller 52 which is comprised of a standard 12V hydraulic pump and two solenoids switches (not shown). The controller 52 is encased for protection and mounts to the platform 42. One of the solenoid switches is used to control operation of the grapple hydraulic cylinders 40, while the other solenoid switch controls operation of hydraulic cylinder 50. A remote push-button control 54 is wired to the controller 52 to operate the solenoid switches. The push-button control 54 has five buttons 56A-E. Buttons 56A and 56B expand and contract the hydraulic cylinders 40 to open and close the grapple 12, respectively. Buttons 56C and 56D expand and contract the hydraulic cylinder 50 to pivot the grapple 12, respectively. Button 56E is a “kill” button which immediately stops operation of all grapple functions. The “kill” button 56E is preferably protected to prevent inadvertent activation.

In an alternate embodiment, the grapple 12 may be configured to connect directly to the boom of an implement service truck (not shown). An interface can be created such that upon proper connection to the boom, the operation of the grapple can be controlled from the truck, much like any other connected implement.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tire handling system for attachment to a lift having controls for operating a movable carriage having at least two forks, the system comprising:
a platform which connects to the forks of the lift carriage;
a grapple comprised of a plurality of arms, wherein each of the arms includes a stationary portion and an engagement bracket, and at least one arm includes an adjustable portion for extending and contracting a length of the at least one arm with the engagement bracket positioned on the adjustable portion, and wherein the plurality of arms are arranged to define an area between the engagement brackets having a perimeter greater than the circumference of a tire to be handled; and
a connector between the platform and the grapple which allows pivoting and rotation of the grapple.

2. The tire handling system of claim 1, further comprising a first hydraulic cylinder connected to the adjustable portion of the at least one arm of the grapple to move the adjustable portion, wherein the first hydraulic cylinder is operated by the controls of the lift.

3. The tire handling system of claim 2, wherein each of the plurality of arms includes an adjustable portion for extending and contracting a length of the arm with the engagement bracket positioned on the adjustable portion of the arm.

4. The tire handling system of claim 3, wherein each of the plurality of arms includes a first hydraulic cylinder connected to the adjustable portion.

5. The tire handling system of claim 1, further comprising a second hydraulic cylinder positioned on the frame and connected by one end to the platform and another end to the grapple for moving the grapple via the connector, wherein the hydraulic cylinder is operated by the controls of the lift.

6. The tire handling system of claim 5, wherein the second hydraulic cylinder pivots the grapple in a substantially vertical direction.

7. The tire handling system of claim 1, wherein the connector comprises a pivot.

8. The tire handling system of claim 7, wherein the connector further comprises a mechanism which allows the grapple to be rotated within a range of about ±10 degrees.

9. The tire handling system of claim 1, wherein the number of arms is three.

10. The tire handling system of claim 9, wherein the length of each arm is manually extended and contracted by a mechanical mechanism.

11. A tire handling system comprising:
a platform for connection to a vehicle;
a grapple comprised of a plurality of arms, each arm including a stationary portion and an engagement bracket, at least one arm including an adjustable portion coupled to the stationary portion and having the engagement bracket thereon, wherein the plurality of arms are arranged to define an area between the engagement brackets having a perimeter greater than the circumference of a tire to be handled;
a connector coupling the grapple to the platform and configured to allow pivoting and rotation of the grapple relative to the platform.

12. The tire handling system of claim 11, further comprising a first hydraulic cylinder for moving the adjustable portion of the at least one arm of the grapple.

13. The tire handling system of claim 12, wherein the grapple comprises three arms.

14. The tire handling system of claim 13, wherein each of the three arms comprises an adjustable portion and a first hydraulic cylinder for moving the adjustable portion relative to the stationary portion.

15. The tire handling system of claim 11, further comprising a second hydraulic cylinder positioned on the platform and connected by one end to the vehicle and another end to the grapple for pivoting the grapple via the connector.

16. The tire handling system of claim 15, wherein the second hydraulic cylinder pivots the grapple in a substantially vertical direction.

17. The tire handling system of claim 11, wherein the connector allows the grapple to be rotated within a range of about ±10 degrees.

18. A tire grapple comprising:
a central hub; and
a plurality of arms extending from the central hub,
wherein each arm includes a stationary portion and an engagement bracket, and at least one arm includes an adjustable portion connected to the stationary portion and having the engagement bracket thereon, the arms being arranged to define an area between the engagement brackets having a perimeter greater than the circumference of a tire to be handled.

19. The tire grapple of claim 18, further comprising a platform having a connector coupled to the central hub, wherein the platform connects to a vehicle for supporting the grapple in a position to permit engagement with a tire.

20. The tire grapple of claim 19, wherein the connector allows pivoting of the grapple in a vertical direction.

21. The tire grapple of claim 18, wherein the connector allows the plurality of arms to rotate within a range of about ±10 degrees about the central hub.
